(19) United States
(12) Patent Application Publication
(10) Pub. No.: US 2019/0370788 A1
(43) Pub. Date: Dec. 5, 2019

(54) System and Method for asset backed crypto-currency to be used as a payment method through the issue of convertible blockchain-tokens, issued to a person who provides their personal data.

(71) Applicant: Terry Aronson, Hallandale Beach, FL (US)

(72) Inventor: Terry Aronson, Hallandale Beach, FL (US)

(21) Appl. No.: 16/430,155

(22) Filed: Jun. 3, 2019

Related U.S. Application Data
(60) Provisional application No. 62/679,101, filed on Jun. 1, 2018.

(51) Int. Cl. G06Q 20/36; G06Q 20/06; G06F 8/20; G06Q 30/06; G06Q 30/08; G06Q 30/02; H04L 9/06

(52) U.S. Cl. CPC G06Q 20/3672; G06Q 20/0658; G06F 8/24; H04L 9/0637; G06Q 30/08; G06Q 30/0217; G06Q 30/0641

(57) ABSTRACT

The present invention is a novel system and method for coding, programming and administering a cryptocurrency platform.

### INDEX TO RELATED APPLICATIONS

This application claims benefit to and is a non-provisional of U.S. Provisional Patent Application 62/679,101 filed Jun. 1, 2018 the disclosure of which is incorporated herein by reference in its entirety.

### SUMMARY OF THE INVENTION

In one embodiment, the present invention is a system and method for issuing and managing blockchain crypto currency and blockchain crypto tokens to members and/or customers having the steps of:

issuing of portal blockchain Cryptocurrency and Portal blockchain Crypto-token by a Portal, said “Portal” is a cloud-based ecosystem of both merchants, surveys, political pollsters and customers and/or members;
providing a number of Platforms in said portal, said platforms including Customer-member Platform, Merchant Platform, eCommerce Platform, a blockchain Cryptocurrency Platform, messaging and communications platform, blockchain crypto-token and blockchain cryptocurrency exchange platform, a blockchain cryptocurrency exchange platform, a merchant and political-survey “bid/ask” platform and Games Platforms;
providing the customer and/or members with products and/or services by merchants;
configuring said Portal with an eCommerce site for merchants to post products and/or services for customer/members to purchase;
configuring said portal for Merchants bid for access to customer/members on the Portal Merchant “bid/ask” auction-platform;
Paying members for their data in blockchain crypto-tokens by providing Crypto-tokens to members and/or customers for providing their personal details (their personal data) to the Portal, said providing Crypto-tokens allows the Portal to provide merchants “focused marketing” to customers, whereby customers and/or members are also “paid” crypto-tokens as a “reward” for viewing and acknowledging merchant advertising. All transactions are coded (programmed) to be “automated” on the blockchain and coded (programmed) “dashboards” allow for upgrades and modifications on the blockchain;
optionally providing customers and/or members a mechanism to convert blockchain crypto-tokens into cryptocurrency to make purchases on any of the Portal's Platforms including on the eCommerce Platform, and/or “automatically” converting blockchain crypto-tokens into blockchain cryptocurrency and/or fiat currency AFTER member and/or customer is “approved” by the compliance platform;
configuring said Portal with a “compliance” that must approve any customer and/or member who acquires or purchases blockchain cryptocurrency on the Portal;
configuring said Portal with an “Exchange Platform” that sells Portal cryptocurrency at a fixed fee in USD and the “Exchange Platform” acquires this Portal cryptocurrency at the same price; and
“programming” the blockchain cryptocurrency to “automatically” charge a small “transaction fee” as a percentage of each of the cryptocurrency sales executed on the Portal Exchange Platform

In one embodiment, the present invention provides a more efficient method of managing “reward points” (frequent flyer miles, etc.) Peer-to-Peer (without any “3rd party validators) and automating their conversion into either (1) cash, (2) coupons or (3) Cryptocurrency—using the blockchain.

3. Coding (programming) on the blockchain allows the “automation” of these processes.

### BRIEF DESCRIPTION OF THE SEVERAL VIEWS OF THE DRAWINGS

FIG. 1 is a flowchart showing the portal and its platforms for members to be paid for their personal “data” and for members and/or customers, merchants, surveys and pollsters to trade, transact for this data, and they can buy and sell blockchain cryptocurrency according to one embodiment of the present invention, providing that, as a member and/or customer is paid for their “data”, they receive payment in the form of blockchain crypto-tokens.

FIG. 2 is a flowchart of crypto currency in crypto-token lifecycle according to one embodiment of the present invention.

FIG. 3 is a flowchart showing platform actions in compliance according to one embodiment of the present invention.

FIG. 4 is a flowchart showing an audit process according to one embodiment of the present invention.

FIG. 5 is a flowchart showing a creation process according to one embodiment of the present invention.

FIG. 6 is a flowchart showing a platform and exchange process according to one abutment of the present invention.

FIG. 7 is a compliance and arbitration process according to one embodiment of the present invention.

FIG. 8 is a flowchart showing creation of crypto tokens according to one embodiment of the present invention.

FIG. 9 is a flowchart showing a portal exchange platform according to one embodiment of the present invention.

FIG. 10 is a flowchart demonstrating an auction process coded (programmed) on the Portal's blockchain.

FIG. 11 is a flow chart showing an e-Commerce platform according to one iteration of the present invention.

FIG. 12A a is a flowchart demonstrating both the issue of: (1) Portal blockchain wallet and the receipt of payment (in the form of Portal blockchain crypto-tokens) for a member and/or customer personal data, (2) the further issue of Portal's blockchain crypto-tokens for both “quality” and “quantity” of this personal data, and (3) the means for that customer and/or member to transact their Portal crypto-tokens into either cash or Portal cryptocurrency via the Portal's “compliance and exchange” process, according to one iteration of the present invention.

FIG. 12 B is a flowchart demonstrating an affiliated wallet.

FIG. 13 is one embodiment of an access screen.

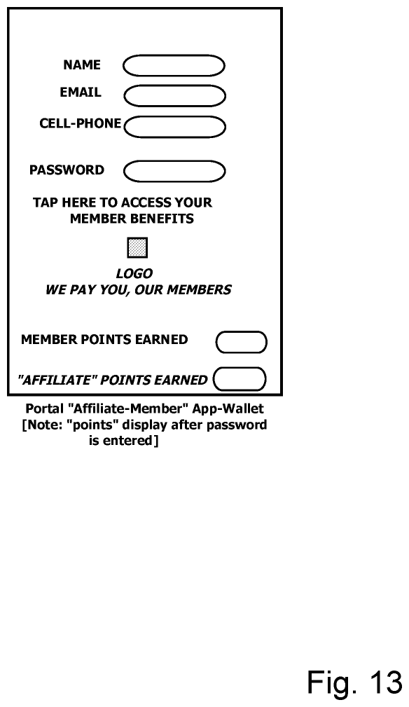

FIG. 14 is one embodiment of an access screen.

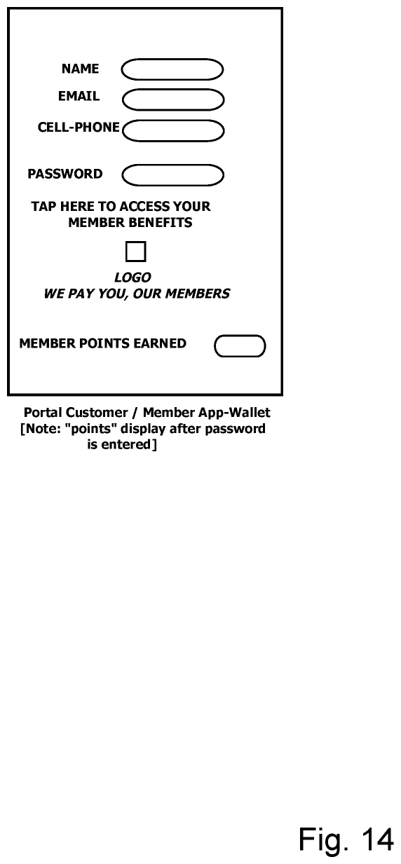

### DETAILED DESCRIPTION OF THE PREFERRED EMBODIMENT

This invention provides members and/or customers the ability to be paid in crypto-tokens and/or cryptocurrency for their data; the crypto-tokens can be converted into cryptocurrency after a compliance department (Platform) approves the conversion. The process involves an Exchange. Specific coding (programming) of the Portal blockchain (either a dedicated blockchain and/or a commercial (paid-transaction type) blockchain) allows for a number of coded (programmed) “dashboards” to allow the Portal administrator to change/modify/upgrade any of the transactions between the Portal's member and/or customer, merchant, supplier, pollster marketeer and/or advertising service provider using the Portal's many Platforms.

The present invention is a Portal Cryptocurrency Exchange Platform (after the approval of a compliance department) allows for the “exchange” of fiat-currency ($-dollar, Euro, etc.) for cryptocurrency; the exchange of crypto-tokens for cryptocurrency; the exchange of cryptocurrency for merchant and/or supplier and/or marketeer “coupons”; redeem cryptocurrency for fiat-currency.

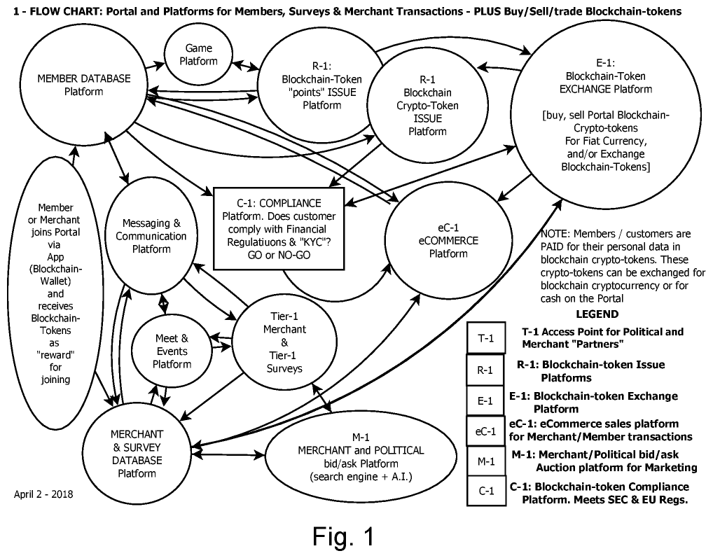

This is achieved through the following procedures and processes. Reference being made to the flowcharts presented in the Figures In reference to FIG. 1—Portal and Platforms for Customers and/or members and Merchants and/or pollsters, and/or marketeers to receive blockchain-tokens for their data; to Trade/Buy/Sell Cryptocurrency and Crypto-tokens; to provide customers and/or members and/or merchants and/or marketeers an access to both join the Portal and be PAID for their personal and corporate data; providing an ecosystem to provide customers and/or members and/or merchants and/or marketeers an ecosystem to join the Portal, to find exciting and compelling events, to play the latest games (such as video games), to communicate with each other, to purchase and transact products and services, to receive polling-surveys and to receive compelling and exciting products and services at compelling prices.

This diagram provides the Portal overview and includes the Portal's Platforms.

The blockchain “white paper” (blockchain contract) allows the blockchain to be programmed (specific coding that permits the blockchain contract to be viewed and modified by the administrator via a “dashboard” to meet this criteria) to automatically pay members and/or customers to be paid for their personal data and receive crypto-tokens in a quantity that is proportional to the amount AND quality of data given. This “data” is then available to be searched, using propriety developed coded programmed) “augmented intelligence” to match-up merchants and/or pollsters with members and/or customers who meet their selected criteria. On the other side of the equation, the quantity of crypto-tokens paid to members and/or customers for their personal data allows the Portal to require payment from merchants and/or political pollsters for this data (via specific coding that permits the blockchain contract to be modified to meet this criteria). The blockchain records all the issue of crypto-tokens and, as such, provides an unalterable record of such payments for data and can be (is) provided to merchants and/or pollsters as part of the “invoice” to same merchants and/or pollsters via specific coding that permits the blockchain contract to be modified to allow this criteria to be implemented and automated.

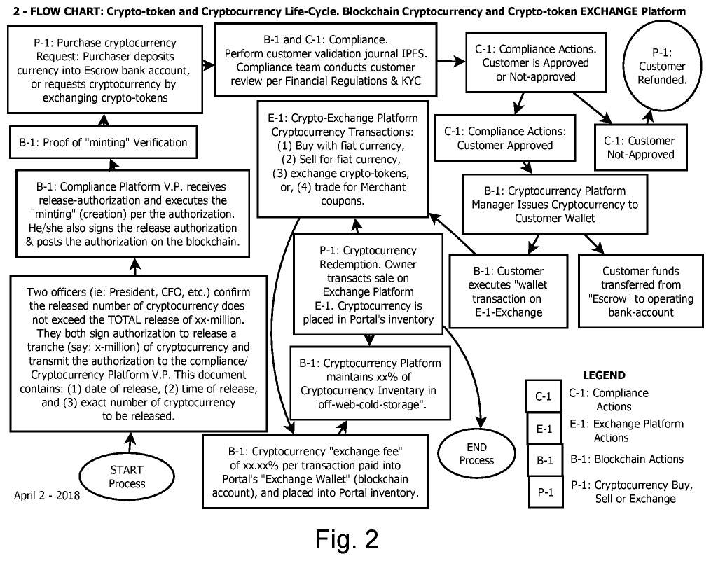

In reference to FIG. 2—Cryptocurrency and Crypto-token Life-Cycle. Overview of Cryptocurrency and Crypto-token EXCHANGE Platform.
This Diagram covers two processes, coding (programming) Portal's Cryptocurrency and Crypto-token Life-Cycle AND Portal's cryptocurrency EXCHANGE Platform.
Portal's Exchange Platform: The Platform where customers and/or members and merchants and/or pollsters and/or marketeers buy, sell, trade, provide “coupons” or convert Portal crypto-tokens into Portal cryptocurrency. The additional “value proposition” is that this exchange will provide a “buy or sell” price that is at a fixed price (ie: at a fixed price of, say, $1.00 ($-us) per Portal blockchain cryptocurrency). Purchasers know that they can sell their Portal cryptocurrency they have in their “wallet” (blockchain account) at this price; however, the Portal Exchange is coded (programmed) to charges a “transaction fee of x.xx %”, payable when they transfer the cryptocurrency to the Exchange Platform. In addition, Portal administrator can also code (modify) the percentage “transaction fee” charged on these Portal blockchain cryptocurrency transactions. This “fixed price” for the Portal Cryptocurrency will remain constant; however, it can be coded (programmed) to meet market pricing AFTER the Portal Cryptocurrency is listed on an external blockchain cryptocurrency Exchange. At that time, the price is fixed by the “market” and any potential “market premium” can build. NOTE: all transactions that involve both cash and/or Portal cryptocurrency must be approved by the compliance department (Platform) to meet present and future security requirements especially focused upon AML and KYS that the regulators (especially SEC in the U.S. and the European Union regulators impose) This is achieved with coding (Programming) the Portal blockchain via an Portal Exchange managed “dashboard”. A large quantity of both Portal crypto-tokens and cryptocurrency is maintained in “off-network” storage (“cold-storage) to eliminate potential theft.

The Portal blockchain is coded (programmed) using specific coding that permits the blockchain contract to be modified (via a “dashboard” to “automate” the process so that “compliance”, after approval of a customer/member/merchant/pollster, will be automatically notified if that customer/member/merchant/pollster exceed (do not comply with) certain criteria, such criteria as may be required by the U.S. Securities and Exchange Commission (SEC) or other such regulator (European Union, banks, etc.). Further, security is provided by maintaining a large percentage (xx %) in “off-the-Internet-storage” (also known as “cold storage”), so denying “hacker access” to either the blockchain crypto-tokens or the blockchain cryptocurrency so stored.

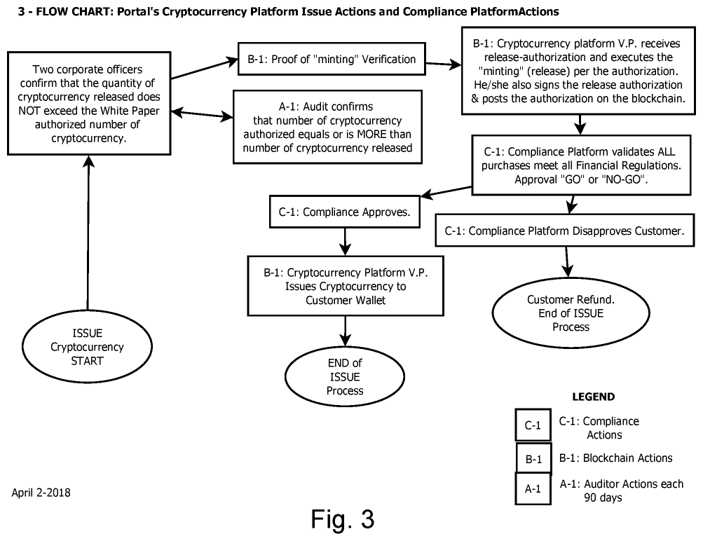

In reference to FIG. 3—Portal's Issue Cryptocurrency Platform Actions and Compliance Platform Actions. Portal blockchain cryptocurrency is issued by coding (programming) the Portal blockchain per the Portal blockchain white paper (blockchain contract). In the event that the Portal cryptocurrency coding (programming) does not meet Portal compliance requirements, then the coding (programming) is invalidated and the issue of the Portal cryptocurrency is terminated.

This flowchart allows the “compliance” to program the blockchain so that the blockchain “contract” can be modified/upgraded using specific coding that permits the blockchain contract to be modified to meet this criteria, so as to meet any future security regulations (security requirements), typically regulations such as Anti Money Laundering (AML) or Know Your Customer (KYC).

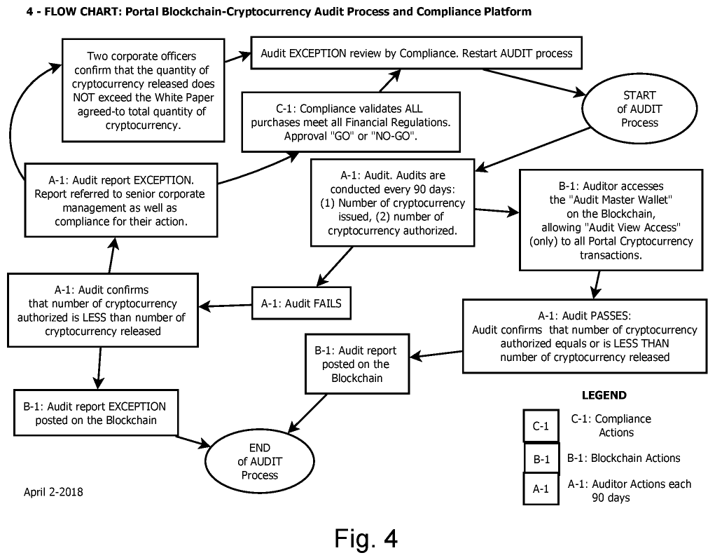

In reference to FIG. 4—Portal Cryptocurrency Audit Process on the Portal's Compliance Platform. The audit process is coded (programmed) to be conducted every xx days (typically 90 days). All audits are coded (programmed) and posted on the Poral blockchain for all members/customers/merchants/pollsters/marketeers to view. This process assures all owners, purchasers that the Portal cryptocurrency will not be issued in excess of the stated quantity.

Such “audits” validate the value of the blockchain cryptocurrency by complying with the blockchain “programming” (via specific coding that permits the blockchain contract to be viewed and modified to meet this criteria) allowing for a predetermined/published total issue quantity of such blockchain cryptocurrency.

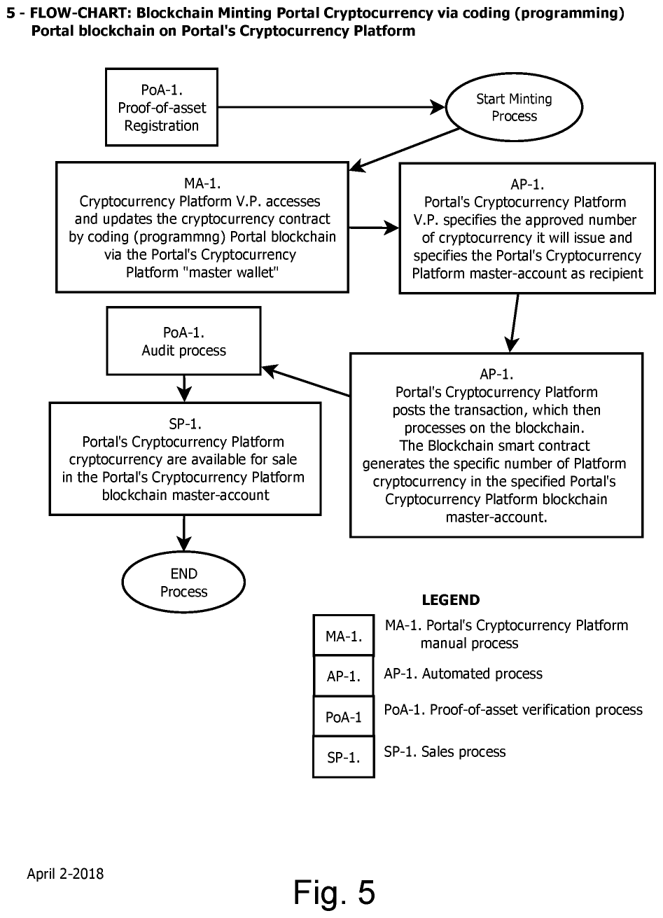

In reference to FIG. 5—Minting (coding, programming and creating) Portal Cryptocurrency on Cryptocurrency Platform. This process employs a specifically coded (programmed) Portal blockchain “master wallet”. The Portal Administrator specifically codes (programs) the issue of new Portal blockchain cryptocurrency in a quantity that is less than or equals the issue limit per the Portal cryptocurrency blockchain white paper (Blockchain contract); such issue must comply with audits (per FIG. 4) that are coded (programmed) and posted on the Poral blockchain for all members/customers/merchants/pollsters/marketeers to view. This process assures all owners, purchasers that the Portal cryptocurrency will not be issued in excess of the stated quantity.

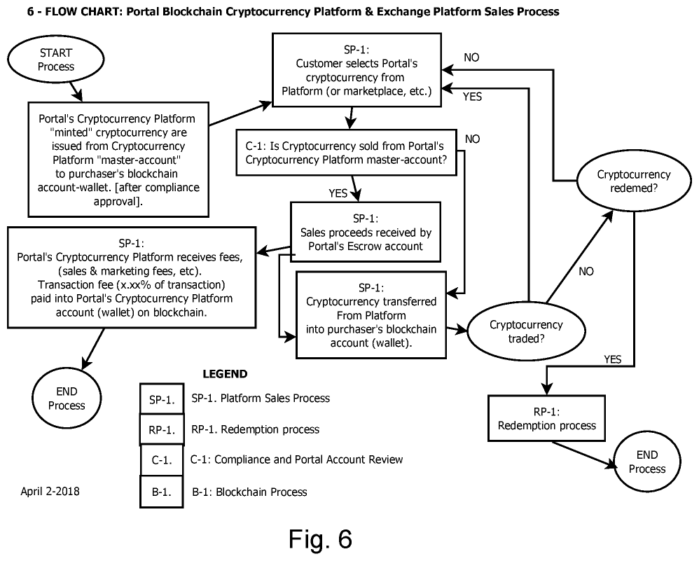

In reference to FIG. 6—Portal Cryptocurrency Platform and Exchange Platform Sales Process. This sales process is coded (programmed) such that after the Portal blockchain cryptocurrency is “minted” (created) such sale transactions are coded (programmed) to be automated regarding the transfer (trade) or purchase of Portal crypto-tokens (Crypto-tokens typically paid to customers and/or members for their personal or corporate data) into Portal cryptocurrency.

Specific coding (programming) automates each transaction whereby each transaction generates a “fee” as a percentage (x.xx %) of each transaction that is paid into the Portal's blockchain cryptocurrency wallet. Coding also allows for this “fee” to be modified or eliminated at the discretion of the Portal's administrator.

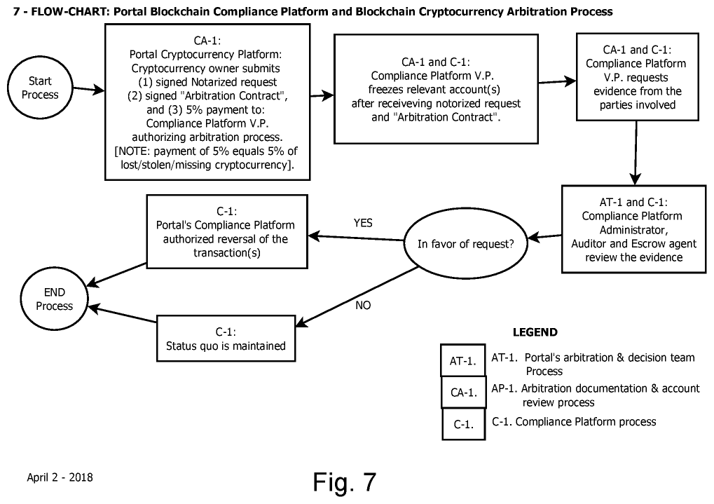

In reference to FIG. 7—Portal Compliance Platform Cryptocurrency Arbitration Process. Specific coding (programming) of the Portal blockchain permits the Portal cryptocurrency and Blockchain crypto-tokens, in the event of theft or loss, to be “frozen”, redeemed and, if appropriate, reissued by the Portal administrator. This is done through a coded (programmed) blockchain Portal-master-wallet.

Coding in the blockchain allows the Portal administrator to both track and “lock” the Portal's cryptocurrency and crypto-tokens in the event of either theft or ownership-dispute. This “Arbitration Process” is coded (programmed) into the Portal's blockchain allowing such modifications.

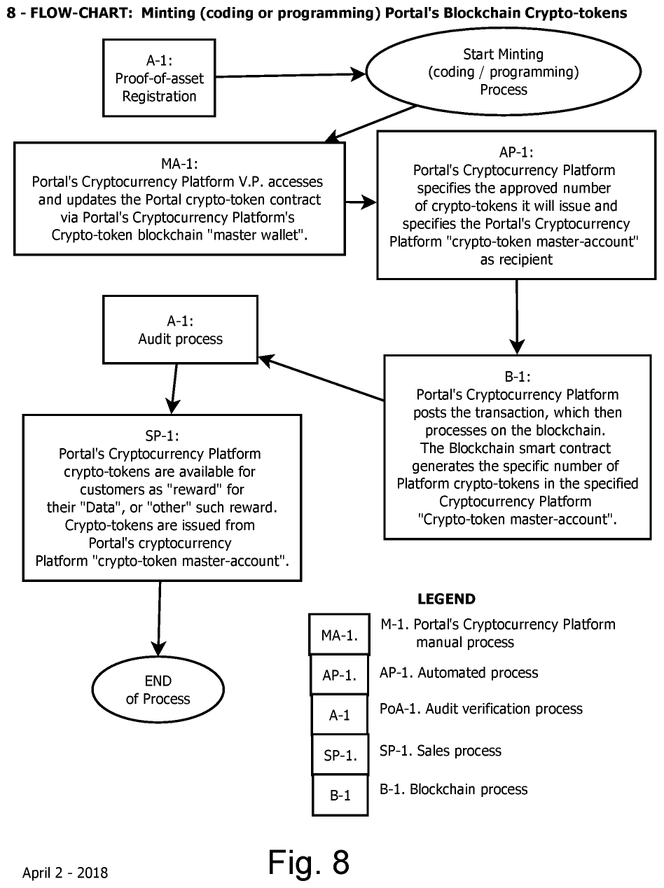

In reference to FIG. 8—Minting (coding, programming and creating) Portal Crypto-tokens on Portal blockchain Platform. This process employs a specifically coded (programmed) Portal blockchain “master wallet”. The Portal Administrator specifically codes (programs) the issue of new Portal blockchain crypto-tokens in a quantity that is less than or equals the issue limit per the Portal crypto-token blockchain white paper (Blockchain contract); such issue must comply with audits (per FIG. 4) that are coded (programmed) and posted on the Portal blockchain for all members/customers/merchants/pollsters/marketeers to view. This process assures all owners, purchasers that the Portal cryptocurrency will not be issued in excess of the stated quantity.

This process is covered by the Portal's “blockchain contract” and is coded (programmed) accordingly.

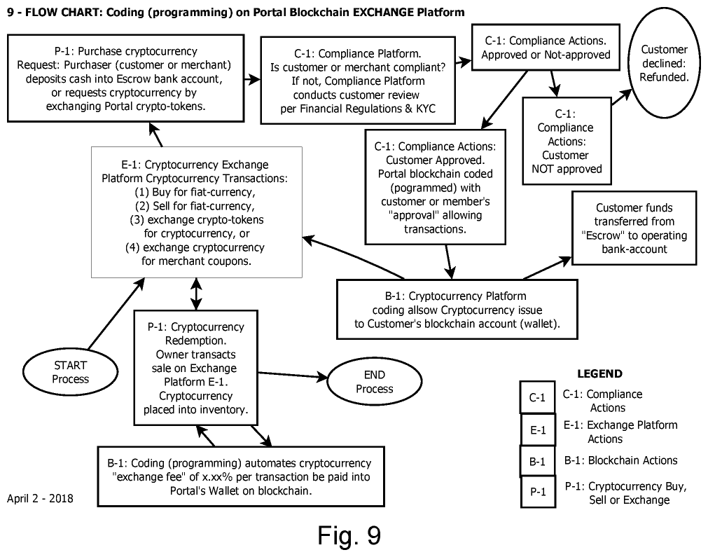

In reference to FIG. 9—Portal Exchange Platform. This Portal Exchange department (platform) is coded (programmed) to meet all financial regulations regarding the issue of blockchain cryptocurrency.

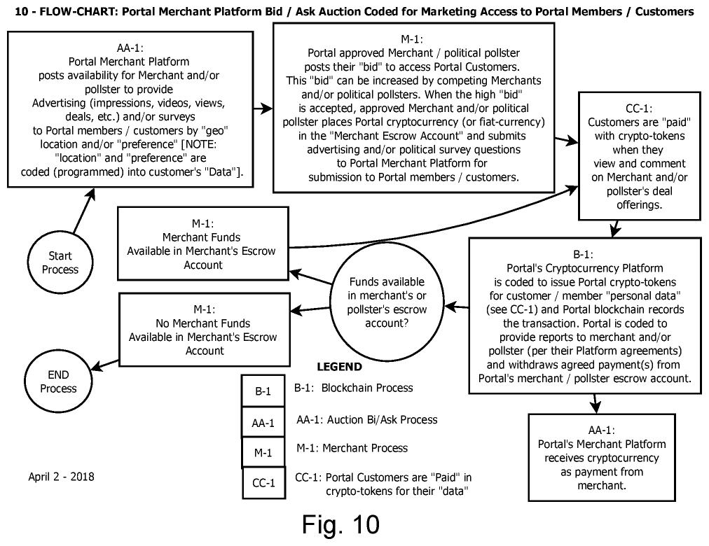

In reference to FIG. 10—Portal Merchant Platform Bid/Ask/Auction for Access to Portal Customers. This Platform is coded (programmed) to allow the merchant/marketeer/pollster to place a bid-price on access to Portal customers and/or members and/or merchants and/or marketeers and/or pollsters. Such access allows the bidding party to access Portal customer and/or member and present their marketing/surveys/product/service/video to these Portal customers and/or members while these customers and/or members access Portal or access Portal events or access Portal games, etc. Payment for these services are made via the Portal escrow-account and coding (programming) permits the automatic payment and invoicing process. Modifications to the bid/ask auction platform are made by the Portal administrator via the “Auction Portal Dashboard” that provides the Portal administrator the means of coding (programming) amendments and changes to the Portal bid/ask Auction Platform.

This process codes(programs) the blockchain to “automate” Portal's blockchain to allow for: (1) payment of blockchain crypto-tokens to members/customers, and (2) “invoice” (automatically remove “payment”) from the merchant/pollster “escrow account”, and (3) funds are removed from the “escrow account” according to the recorded “payment” of crypto-tokens to the member/customer.

This blockchain coding (programming) has numerous advantages: (1) the records can-not be modified and are time and date coded on the blockchain and recoverable/viewable for “audit” purposes, (2) Coding (programming) allows for immediate payment to member and/or customer with blockchain crypto-tokens AND the merchant/pollster is “invoiced” for the transaction (and/or survey) and the Portal's coding (programming) permits Portal to automatically removes funds from the merchant/pollster “escrow account”, and (3) Coding (programming) permits the removal of funds according to the “bid” that the merchant/pollster made on the “bid/ask” Platform. Specific coding (programming) automates this blockchain process, thus eliminating the many-step (typically labor intensive) processes that are utilized in non-blockchain processes according to one embodiment of the present invention.

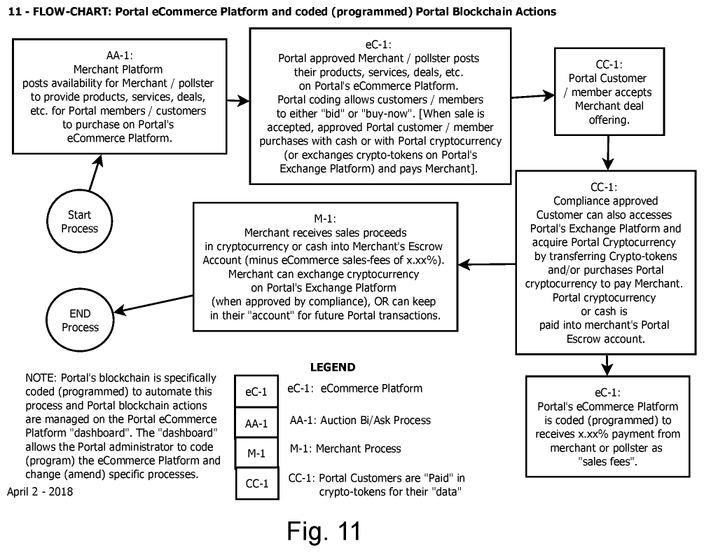

In reference to FIG. 11—Portal eCommerce Platform. This Platform is coded (programmed) to allow the merchant/marketeer/pollster to place their products/services on this eCommerce Platform to be auctioned OR sold for a posted price to Portal customers and/or members and/or merchants and/or marketeers and/or pollsters. The eCommerce Platform allows merchants, etc. to access Portal customer and/or member and present their marketing/surveys/product/service/video/games (etc.) to Portal customers and/or members while these customers and/or members access Portal. Payment for these services are made via the Portal and coding (programming) permits the automatic payment and invoicing process. Modifications to the eCommerce platform are made by the Portal administrator via the “eCommerce Platform Dashboard” that provides the Portal administrator the means of coding (programming) amendments and changes to the Portal eCommerce Platform.

As understood herein, the following terms are defined:

Portal: The Portal is an “ecosystem” where customer and/or member and merchant and/or pollster and/or marketeer access. Portal is accessed via Apps, Internet, etc. giving access to the Portal ecosystem (see 1—Flow Chart).

Portal's Customer Database Platform. The location the stores customer's data. Customers are PAID for their Personal Data with Crypto-tokens. Portal crypto-tokens are issued to Portal customers and/or members for providing their personal data and other specific actions and transactions. Portal customers, after compliance approval, trade these crypto-tokens for cryptocurrency and/or cash (or they can purchase Portal's cryptocurrency. (see 1—FlowChart and 8—Flow Chart).

Portal's Merchant Database Platform. The location that stores merchant's data (see 1—Flow Chart).

Portal's Crypto-token Issue Platform. The location where crypto-tokens (points) are issued to customers after the customers complete certain tasks. Crypto-tokens have no actual value; however, they can be converted into cryptocurrency on the Portal-Exchange Platform. (see 8—Flow Chart).

Portal's Cryptocurrency Issue Platform. The location where cryptocurrency is issued. Portal's other “crypto” is a crypto-token. Portal crypto-tokens (“points”) are issued to qualified Portal customers while they are accessing Portal. Portal customers can trade these crypto-tokens for Portal's cryptocurrency (and/or they can buy Portal's cryptocurrency) and then these customers can purchase various products and services on Portal with Portal's cryptocurrency via Portal's eCommerce Platform, etc. NOTE: all cryptocurrency purchases or “trade of crypto-tokens” must be approved by Portal Compliance. (see 3—Flow Chart and 9—Flow Chart).

Portal's eCommerce platform. The location where merchants and customers buy, sell or trade products and/or services (see 11—Flow Chart).

Portal's Merchant Bid/Ask Platform. The location where merchants bid to advertise their products or services to Portal customers, and/or receive access to Portal customers. (see 10—Flow Chart). Portal's Compliance Platform. The location where a customer receives approval to receive Portal cryptocurrency. The Compliance platform reviews the customer's application and provides a “go” or “no-go” for the issue of cryptocurrency. This platform complies with Financial Transaction regulations (such as KYC) in all Portal customer's Countries. (see 2—Flow Chart and 3—Flow Chart).

Portal's Exchange Platform. The Portal Platform where customers and merchants buy, sell, provide “coupons” or convert Portal crypto-tokens into Portal cryptocurrency. The typical Portal Cryptocurrency “buy” or “sell” price is done initially, at a fixed price. (see 2—Flow Chart and 6—Flow Chart). This Diagram covers two processes, Portal's Cryptocurrency and Crypto-token Life-Cycle AND Portal's cryptocurrency EXCHANGE Platform.

Portal Apps are one means of Accessing Portal: Apps provide direct access to Portal's platforms, especially Portal's eCommerce Platform. Portal is easily accessed via phone Apps, PC or MAC. Special Portal Apps give customers “one-click access” to Portal's eCommerce Platform, Portal's Exchange Platform, etc.

Portal Wallet: Is an “electronic” blockchain access point (accessed via PC, MAC, mobile device, etc.) allowing customers to buy/sell/transact/trade their cryptocurrency or crypto-tokens. The Portal Wallet is provided free to customers to store their cryptocurrency and their crypto-tokens. Wallet comes with 2-level password protection.

Customers are Paid for their Data: Customers are REWARDED for their personal data, they receive crypto-tokens after they complete their application on a “free-wallet”. By providing their personal data in the on-line form in their new Portal Wallet, they receive crypto-tokens in their new Portal Wallet as payment for this data. Portal Wallet is a secure and encrypted electronic-storage/distribution media for Portal cryptocurrency.

Portal Affiliate Marketing Wallet: Portal's cryptocurrency “white paper” (blockchain contract) allows Portal code (program) and issue their “Portal affiliate wallet” (Portal wallet is a secure and encrypted electronic-storage/distribution media for cryptocurrency). Portal distributes specific Portal affiliate wallets to selected Portal marketing-team customers, corporations and to “influencers”. Portal's affiliate wallet allows these selected Portal marketing-team customers to distribute (share) their Portal affiliate wallet to their database of friends/family/business-associates/social-media-contacts, etc. Each “affiliate Contact” who purchases Portal offerings and/or Portal cryptocurrency through their Portal wallet (generated via Portal affiliate wallet) generates “commission” (a percentage of the cryptocurrency purchase) into the referring Portal affiliate's wallet. The “contact” follows the simple process: customer opens the Portal affiliate wallet; downloads and sets-up their free Portal Wallet; receives Portal crypto-tokens as payment for their personal data; Then this “contact” transacts on the Portal for eCommerce offerings, games, events, etc. Immediately this transaction is complete and approved by Portal Compliance, commission is paid; Affiliate commissions are made on the blockchain, directly into the referring Portal affiliate's wallet.

Revenue

Revenue from Portal's eCommerce Platform. Portal provides customers access to Portal's eCommerce Platform (and its online Catalog). Customers are rewarded with Crypto-tokens (loyalty points), while they are active in the Portal.

Portal Smart Apps: Customers who use the Portal's App, arrives via “one-click” to Portal, and Portal “knows” each customer's preferences via the customer platform “look-up” and review of customer's data and preferences. Thus, eCommerce platform provides customers immediate access to their “preferences”.

Revenue from all Customers: Portal receives revenue through online advertising (directly on the Portal), Merchant partnerships and pollster partnerships, Private label online “in house” offerings, polling surveys, through Portal cryptocurrency transactions on Portal platforms, transactions (sales) on Portal eCommerce Platform, through the Portal event Platform, through the video game Platform, etc.

Revenue from Portal's Exchange Platform: As the volume of users grows, and customers use Portal's cryptocurrency, the value proposition of the Portal cryptocurrency will increase as soon as Portal cryptocurrency is listed on a blockchain cryptocurrency exchange when Portal cryptocurrency “premium” has the opportunity to increase. [“Premium” is defined as increase in the “face value” of the Portal's cryptocurrency]. Thus, Portal cryptocurrency can become an asset of value to be desired by users, merchants and investors within Portal ecosystem as soon as the listing on a cryptocurrency exchange.

Revenue from Merchant Advertising to Portal Customers and/or members: All customers and/or members of the Portal are “paid” with crypto-tokens when they provide their personal data. Customers are “paid” when they complete their “preferences”, review eCommerce offerings, receive appropriate “paid advertising” material from merchants, pollsters and/or marketeers, provide their preferences, provide personal data, etc.

Merchants pay Portal: Payment is based upon “quantified activity reports”. These reports are based upon customer access to Portal and this is achieved by tabulating the number of Portal crypto-tokens earned by these Portal customers and/or members and/or merchants and marketeers while they are on Portal.

Portal's Revenue from Merchants, pollsters and marketeers: (1) merchants pollsters and marketeers can pay subscription, (2) Merchant pollsters and marketeers pay for access to Portal's customer “data analytics”, (3) merchants pollsters and marketeers pay to message Portal customers (through Portal communication Platform, “messaging Apps”, email, etc.) (4) merchants pollsters and marketeers pay to market their goods/services/products to Portal customers and/or members, (5) merchants pollsters and marketeers pay for advertising to Portal customers, (6) merchants pollsters and marketeers purchase cryptocurrency to pay for goods and services, advertising, “views” and “impressions”.

Revenue from Portal's Cryptocurrency: Customers and/or members are paid with Portal crypto-tokens and can exchange them for Portal cryptocurrency—Portal cryptocurrency complies with Financial Services regulation compliance requirements (AML and KYC). Portal's cryptocurrency is available for purchase by Portal customers and/or members, allowing customers and/or members to pay for items on Portal. Typically payments on Portal are made via Portal cryptocurrency and/or cash.

Additional Revenue from Portal cryptocurrency: Portal receives a percentage of completed Portal cryptocurrency transactions. Portal receives revenue from the initial sale of Portal cryptocurrency and Portal receives revenue as a “transaction-fee” on all ongoing Portal cryptocurrency transactions. For example, customer and/or member and/or merchant “A” purchases Portal cryptocurrency and sells that Portal cryptocurrency to customer member or merchant “B”. Portal receives a small percentage of that transaction. Customer “B” purchases an item from a merchant with Portal cryptocurrency, Portal receives a percentage of that transaction, etc.

Customers are PAID for their Data. Portal crypto-tokens are “earned” by Portal customers and/or members through a number of methods; Completing their “preferences” and personal information on Portal Wallet or App; time on the Portal=xx Portal crypto-tokens; interaction with merchants, pollsters, marketeers on the Portal; interacting with Portal commercial videos; answering Portal sponsor questions; updating their preference (data analytics on themselves); spending their Portal cryptocurrency; purchases on Portal's eCommerce platform; etc.

Revenue from Customer Access to Portal: Customers earn Portal crypto-tokens (“points”) while actively using the Portal. These Portal crypto-tokens can be converted into Portal's Cryptocurrency to be used as “merchant cash” on Portal's platforms, allowing customers to enjoy a variety of benefits from participating-merchant-customers. Merchants pay to advertise on the Portal, such payments are “tracked” by the issue of Portal's crypto-tokens to customers.

Revenue from Merchants, pollsters and marketeers: Merchants, pollsters and marketeers pay for “Portal merchant membership”. Portal receives revenue from merchant pollster and marketeer subscriptions, advertising, sale of products and services. Thus, Portal provides customers and/or members and/or merchants Portal cryptocurrency-based transactions, a Portal cryptocurrency conversion platform and the Portal Exchange Platform.

Portal is an “ecosystem place” like none other ever created: Portal provides true “lifestyle experience”; a place where customers and/or members congregate; customers and/or members interact and build their own Portal presence; customers and/or members purchase Portal cryptocurrency; customers and/or members take advantage of special merchant, pollster and marketeer opportunities. Portal eCommerce and catalog are highly personalized to each customer and/or member accessing Portal eCommerce Platform. Because Portal eCommerce Platform accesses customer and/or member data from their Portal “preferences”, Portal products and offerings are personal and extremely relevant to that Portal customer and/or member.

Revenue from Customer and/or member merchant-partnerships. Portal receives revenue through Merchant partnerships; private label online “in house” offerings; Portal advertising; Customers and/or members access Portal and receive crypto-tokens at a rate of xx tokens per “active-minute on Portal; Portal customer and/or member receive crypto-token(s) per “viewed impression” from merchants, pollsters and/or marketeers; Merchants BID via Portal's “bid for unique impressions” on Portal bid/ask Merchant Platform; Payments are made by the merchant/pollster/marketeer to Portal's escrow account. All payments are made “in-advance” of services; merchant/pollster/marketeer pay Portal for goods/services/event “unique impressions” by customer and/or member; Portal validates payments from merchant/pollster/marketeer via the Portal crypto-tokens paid to customers.

Revenue from merchant/pollster/marketeer advertising to Customer and/or member: Revenue from merchant/pollster/marketeer to customer and/or member is calculated in a formula similar to “bid-for-impressions”; customer and/or member activity=customer and/or member receives crypto-tokens; crypto-tokens awarded=merchant/pollster/marketeer offering views; merchant/pollster/marketeer offering views=crypto-tokens awarded to customer (member)=billing to merchant/pollster/marketeer based upon customer (member) “impressions”. Cryptocurrency utilization on Portal eCommerce Platform: Portal charges a percentage (xx %) fee for all Portal cryptocurrency transactions.

Portal Cryptocurrency Arbitration: Portal's Cryptocurrency incorporates an “Arbitration” component; This Arbitration component allows Portal to “freeze” certain transactions in the event of theft of Portal's cryptocurrency; Then Portal can return any stolen/misappropriated/lost cryptocurrency to its rightful owner; Portal charges a fee as a xx percentage of the value of the cryptocurrency in question, paid in advance, to initiate the Arbitration process.

Summation—Loyalty Points or Crypto-Tokens

The following are some of the value propositions for Portal customers: Portal customers (members) are paid for their data. Customers (members) earn Portal crypto-tokens (crypto-tokens are similar to frequent flier miles). These Portal crypto-tokens can be redeemed on Portal's Exchange for cryptocurrency and/or cash allowing them to make purchases on Portal's eCommerce platform; Portal's daily “deals” and a multitude of other offerings; relevant discount offerings at places that Portal customers (members) identified they wish to frequent and experience; ability for Portal customers (members) to win relevant prizes; special prizes; specialty products; specialty services; ability for Portal customers (members) to purchase items of great interest at prices that are close to/or less than wholesale. All items are accessed on Portal eCommerce online catalog; Portal eCommerce catalog can be stocked by Portal merchant/pollster/marketeer offering deals to Portal customers (members).

Loyalty Program “Points”: 82-million Americans are customers of some type of loyalty program and receive “points” for “activities” in these programs. 87% of these loyalty program customers are more likely to buy in a “store” accepting (or giving) loyalty program “points” when given the choice of a store offering no loyalty program “points”. 140-million Americans play the lottery. 54% of Americans participate in online loyalty programs because of ease-of-use. American consumers hold 3.9 billion memberships in customer loyalty programs. About half of all Americans play State lotteries, more than 144 million people in the United States alone—the number is much larger world wide! During 2017 49% of Millennials use online coupons, compared to 39% of Gen Xers and 33% of Baby Boomers. The explosion of digital coupon websites and mobile apps is transforming the way consumers shop, especially Millennials. Per eMarketer (Q4 of 2017), 64% of Millennials regularly search for coupons on their smartphones and, in turn, Millennials by-far make up the largest population of singles in America.

Cryptocurrency Regulations in the U.S. The United States Securities and Exchange Commission (SEC) is applying the “know your customer” (KYC) regulations to all current cryptocurrencies. All U.S. cryptocurrency exchanges NOW require that cryptocurrency listed on their exchange comply with “SEC-compliance-regulations” (AML and KYC).

Cryptocurrency Regulations in the EU. The European Parliament April 2018 backed a move to bring closer regulation to cryptocurrencies. The parliament's members voted by a large majority to support a December 2017 agreement with the European Council for measures aimed, in part, to prevent the use of cryptocurrencies in money laundering and terrorism financing.

The parliament passed the move by 574 yes votes to 13 no votes, with 60 abstentions. The new legislation seeks to address the anonymity of the financial technology by implementing rules for cryptocurrency exchanges, platforms and wallet providers. Under the measures, such entities must be registered with authorities and will to have to apply due diligence procedures, including customer verification. According to the release, the updated directive will come into force three days after publication in the Official Journal of the European Union. After that, EU member Countries have 18 months to bring the new rules into national law.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

This Blockchain-efficient process reduces staffing, thus eliminating the requirement to employ large teams of marketing and accounting staff. All “audits” for payments can be accessed through Portal Blockchain “Audit Wallets” on the 100%-unalterable, 100% auditable Blockchain. Transactions on the Portal such as polling, are conducted peer-to-peer and results are tabulated on the Portal blockchain immediately received. A polling “survey” released at 9 am with a 12-hour response, will produce credible results within 6 hours of release and final results 12 hours after release. Since the Portal blockchain eliminates “3^{rd} party review/validation”, results are nor corrupted by 3^{rd} parties. Also, all survey results are 100% auditable, secure and retained on the Portal blockchain. As set forth in FIG. 11, the Portal's blockchain is coded (programmed) to “automate” the transaction process so that all such transactions are saved to the blockchain and saved with pertinent details such as time and date so the Portal can provide the merchant and/or pollster “immediate access”, via an “app” (and/or blockchain wallet) to the transaction process on the blockchain. Thus, the accounting process, accounting for such transactions, is provided to the merchant and/or pollster via a “app” (and/or blockchain wallet) so they can “view” the process or processes in “real-time”, namely within seconds of the transactions completion. This blockchain process is coded (programmed) into the Portal's blockchain thus eliminating “typical” labor intensive accounting/auditing processes and both time and date are recorded so that the transaction is 100% auditable by the merchant and/or pollster.

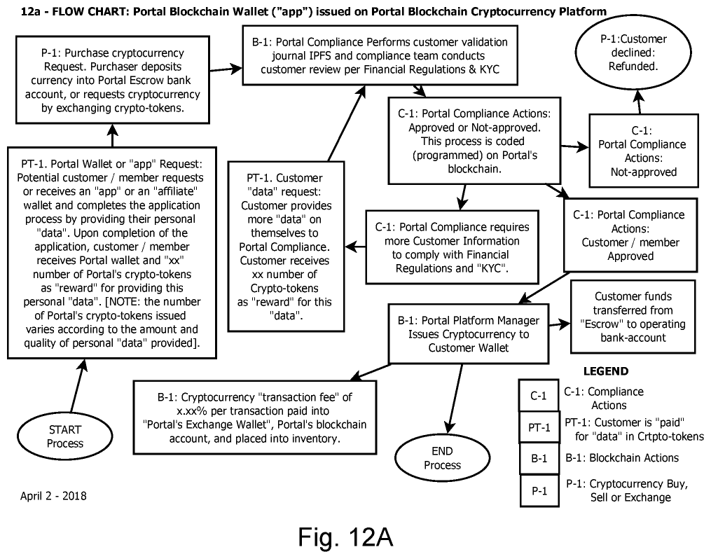

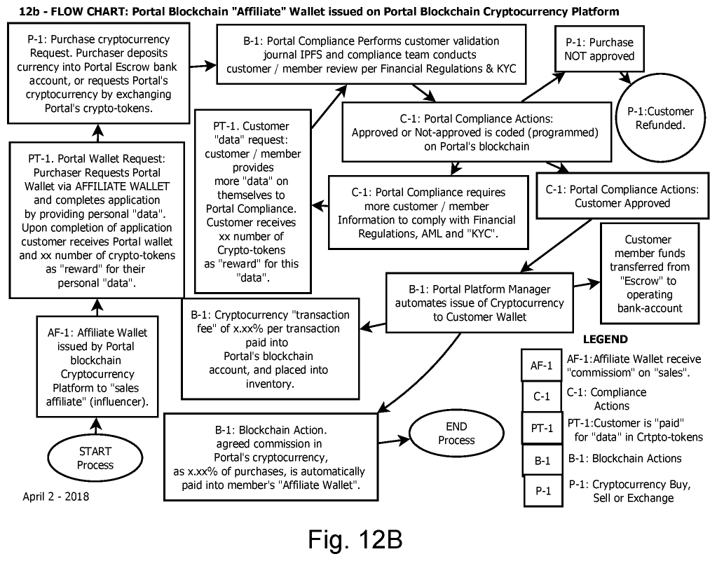

As set forth in FIG. 12B, the Portal's blockchain is coded (programmed) to automate the commission payment process. A customer, member or corporation, selected by Portal's management with a large list of customers and/or members and/or as a “influencer”, is issued with a Portal “affiliate App” (a blockchain “referral” wallet) that allows that “influencer” to forward their “affiliate app” to their friends, acquaintances, followers, customers, etc. Any of these individuals who then accept this “app” and use it to become a customer or member of the Portal, open the “app” (wallet) and complete the application process and are then rewarded with Portal blockchain crypto-tokens for providing their data are then linked as an “affiliate” to the customer, member or corporation and/or an “influencer”, the originator of the “App” (wallet). This linkage is coded (programmed) to pay a x.xx % commission on all revenue that that individual (customer and/or member) generates for the Portal. The Portal's blockchain coding (programming) allows the Portal's administrator to pay commission on all revenue generated for the Portal by this new member and/or customer AND can be coded (programmed) to pay commission on further on-going referrals from this new customer or member to xx levels of referral by this new customer or member. Thus, a small number of referrals by customer, member or corporation and/or “influencers” will rapidly build a large number of customers and/or members in the Portal. according to one embodiment of the present invention.

I claim:

1. A system and method for managing crypto currency having the steps of:
coding the issue of a Portal Cryptocurrency and a Portal Crypto-token on a Portal blockchain (or a commercial blockchain) by a Portal, said “Portal” is a cloud-based ecosystem of merchant/pollster/marketeer and customers and/or members;
coding a number of Platforms in said portal, said platforms including Customer Platform, Merchant Platform, eCommerce Platform, a Cryptocurrency Platform, Games Platforms; events Platform, polling survey Platform, messaging Platform, bid/ask auction Platform;
coding specific “dashboards” allowing both the Portal blockchain and Portal databases to be modified/upgraded/improved by the Portal administrator;
providing the customer and/or member with products and/or services by merchant/pollster/marketeer;
coding said Portal with an eCommerce site for merchant/pollster/marketeer to post products and/or services for customer/members to utilize or purchase;
coding said portal for merchant/pollster/marketeer bid for access to customer/members on the Portal merchant/pollster/marketeer Auction-Platform;
providing Crypto-tokens are to member/customer/Corporation for providing their personal details (their personal data) to the Portal, said providing Crypto-tokens allows the Portal to provide merchants “focused marketing” to customer/member, whereby customer/member is also “paid” crypto-tokens as a “reward” for viewing and acknowledging merchant/pollster/marketeer advertising;
optionally providing customer/member a mechanism to convert Crypto-tokens into cryptocurrency and/or cash to make purchases on any of Portal Platforms including on the eCommerce Platform;
configuring said Portal with a compliance department (Platform) that must approve any customer/member who acquires or purchases cryptocurrency on the Portal;
coding said Portal with an “Exchange Platform” that SELLS Portal cryptocurrency at a fixed fee in USD and the “Exchange Platform” BUYS Portal cryptocurrency at the same price; and
charging a small “transaction fee” in all cryptocurrency sales executed on the Portal Exchange Platform.
